(19) United States
(12) Patent Application Publication
(10) Pub. No.: US 2008/0285046 A1
(43) Pub. Date: Nov. 20, 2008

(54) System and method for improving the resolution of an optical fiber gyroscope and a ring laser gyroscope

(76) Inventor: Larry W. Fullerton, New Hope, AL (US)

Correspondence Address: Larry W. Fullerton, 125 Peter Lane, New Hope, AL, 35760, US

(21) Appl. No.: 12/152,430

(22) Filed: May 14, 2008

Related U.S. Application Data
(60) Provisional application No. 60/930,161, filed on May 14, 2007.

(51) Int. Cl. G01C 19/64

(52) U.S. Cl. 356/459

(57) ABSTRACT

A system and method for improving the resolution of an optical fiber gyroscope and a ring laser gyroscope is provided. Entangled photons are introduced into an interferometer of a gyroscope. One or more detectors detect an interference pattern used to determine the angular velocity of a platform. The interference pattern may be a spatial and/or temporal interference pattern. The detectors may count the sub-wavelength interferometer fringes that indicate the direction and degree of angular rotation about the central axis of the apparatus. The detectors may measure a beat frequency.

### CROSS-REFERENCE TO RELATED APPLICATIONS

This U.S. Non-Provisional Patent Application claims priority to U.S. Provisional Patent Application No. 60/930,161, filed May 14, 2007, which is incorporated herein by reference in its entirety.

### FIELD OF THE INVENTION

The present invention relates generally to a system and method for improving the resolution of an optical fiber gyroscope and a ring laser gyroscope. More particularly, the present invention relates to using entangled photons to realize more precise measurements in an optical fiber gyroscope and a ring laser gyroscope.

### BACKGROUND OF THE INVENTION

It is desirable to have an improved system and method for improving the resolution of an optical fiber gyroscope and a ring laser gyroscope.

As described by Wikipedia, a gyroscope (or gyro) is a device for measuring or maintaining the orientation of an object. Gyroscopes can be used to construct gyrocompasses which complement or replace magnetic compasses, to assist in stability, or be used as part of an inertial guidance system. As such they are used in ships, aircraft, spacecraft, ballistic missiles, and other types of vehicles as well as bicycles and toys.

A ring laser gyroscope (RLG) uses interference of laser light within a bulk optic ring to detect changes in orientation and spin. It is an application of a Sagnac interferometer. RLGs can be used as the stable elements (for one degree of freedom each) in an inertial reference system. The advantage of using an RLG is that there are no moving parts. Compared to the conventional spinning gyro, this means there is no friction, which in turn means there will be no inherent drift terms. Additionally, the entire unit is compact, lightweight and virtually indestructible, meaning it can be used in aircraft. Unlike a mechanical gyroscope, the device does not resist changes to its orientation. Physically, an RLG is composed of segments of transmission paths configured as either a square or a triangle and connected with mirrors. One of the mirrors will be partially silvered, allowing light through to the detectors. A laser is launched into the transmission path in both directions, establishing a standing wave resonant with the length of the path. As the apparatus rotates, light in one branch travels a different distance than the other branch, changing its phase and resonance frequency with respect to the light travelling in the other direction, resulting in the interference pattern beating at the detector. The angular rate is measured by counting the interference fringes. Primary applications include navigation systems on commercial airliners, ships and spacecraft, where RLGs are often referred to as an Inertial Reference System.

RLGs, while more accurate than mechanical gyros, suffer from an effect known as “lock-in” at very slow rotation rates. When the ring laser is rotating very slowly, the frequencies of the counter-rotating lasers become very close (within the laser bandwidth). At this low rotation, the nulls in the standing wave tend to “get stuck” on the mirrors, locking the frequency of each beam to the same value, and the interference fringes no longer move relative to the detector; in this scenario, the device will not accurately track its angular position over time. As such, there is a need for an improved system and method for improving a ring laser gyroscope by mitigating or eliminating lock-in.

A fiber optic gyroscope (FOG) is a gyroscope that uses the interference of light to detect mechanical rotation. The sensor is a coil of as much as 5 km of optical fiber. Two light beams travel along the fiber in opposite directions. Due to the Sagnac effect, the beam traveling against the rotation experiences a slightly shorter path than the other beam. The resulting phase shift affects how the beams interfere with each other when they are combined. The intensity of the combined beam then depends on the rotation rate of the device.

A FOG provides extremely precise rotational rate information, in part because of its lack of cross-axis sensitivity to vibration, acceleration, and shock. Unlike the classic spinning-mass gyroscope, the FOG has virtually no moving parts and no inertial resistance to movement. FOGs are designed in both open-loop and closed-loop configurations and are used in surveying, stabilization and inertial navigation tasks.

The FOG typically shows a higher resolution than a RLG but also a higher drift and worse scale factor performance. As such, there is a need for an improved system and method for improving a fiber optic gyroscope by reducing drift and improving scale factor performance.

Generally, the accuracy of a gyroscope when measuring or maintaining the orientation of an object is a function of its angular resolution. As such, the greater the angular resolution, the greater the accuracy of the gyroscope. Therefore, there is also a need for an improved system and method for improving the resolution of an fiber optic gyroscope and a ring laser gyroscope.

### SUMMARY OF THE INVENTION

Briefly, the present invention is an improved system and method for improving the resolution of an optical fiber gyroscope and a ring laser gyroscope. One aspect of the invention involves a method for determining the angular velocity of a platform relative to a gyroscope including the steps of producing a plurality of entangled particles at a source, introducing the plurality of entangled particles into an interferometer, detecting an interference pattern using one or more detectors, and determining the angular velocity of the platform based upon the interference pattern. The interference pattern may be a temporal interference pattern or a spatial interference pattern. The method may further include the steps of splitting the plurality of entangled particles into a first portion of entangled particles and a second portion of entangled particles, and directing the first portion of entangled particles and the second portion of entangled particles to follow a trajectory in opposite directions.

The plurality of entangled particles may comprise four entangled particles and may comprise photons, atoms, or trapped ions.

Detecting interferometer fringing may involve detecting and counting sub-wavelength fringes that indicate the direction and degree of angular rotation about the central axis of the platform.

The source may produce spontaneous parametric down-conversion.

Another aspect of the invention includes a gyroscope for determining an angular velocity of a platform. The gyroscope includes a source that produces a plurality of entangled particles, an interferometer, where the plurality of entangled particles are introduced into the interferometer, and a detector to detect an interference pattern that is used to determine the angular velocity of the platform. The interference pattern may be a temporal interference pattern or a spatial interference pattern.

The interferometer may be a Mach-Zehnder interferometer, a Sagnac interferometer, a displaced Sagnac interferometer, or a passive ring interferometer.

The gyroscope may be one of a ring laser gyroscope or a fiber optic gyroscope.

The plurality of entangled particles may comprise four entangled particles and may comprise photons, atoms, or trapped ions.

The detector may be a single particle counting detector such as a single photon counting detector.

The source may be a pulsed laser. The pulsed laser may pump a type I phase-matched beta barium borate crystal.

The gyroscope may include polarization-maintaining fibers that guide said photons from said source to said interferometer.

The gyroscope may include single-mode fibers that collect photons from the interferometer and guide the photons to the detector.

The gyroscope may include at least one interference filter.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates an exemplary Sagnac interferometer;

FIG. 2 illustrates an exemplary ring laser;

FIG. 3 depicts an exemplary ring laser gyroscope;

FIG. 4 depicts an exemplary fiber optic gyroscope;

FIG. 5 provides a schematic of an exemplary optical interferometer that employs an intrinsically stable displaced-Sagnac architecture;

FIG. 6 depicts an exemplary gyroscope in accordance with the present invention; and

FIG. 7 depicts an exemplary method in accordance with the present invention.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art. Like numbers refer to like elements throughout.

The present invention provides a system and method for improving the resolution of an optical fiber gyroscope and a ring laser gyroscope.

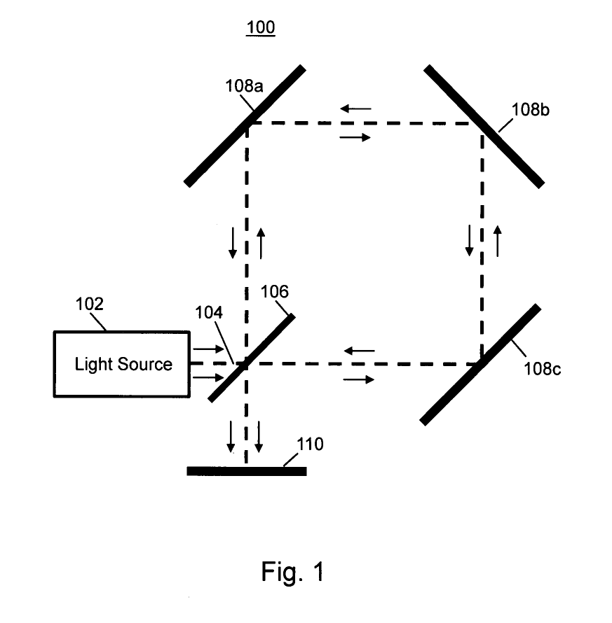

FIG. 1 illustrates an exemplary Sagnac interferometer 100. Referring to FIG. 1, a Sagnac interferometer includes a light source 102 that produces a beam of light 104. Half of the beam of light 104 reflects off a beam splitter (e.g., halfsilvered mirror) 106 and travels in one direction reflecting off of a first mirror 108a, a second mirror 108b, and a third mirror 108c, before again reflecting off of the beam splitter 106 and into a viewing screen 110. The remaining half of the beam of light 104 travels through the beam splitter 106 and reflects off of the third mirror 108c, the second mirror 108b, and the first mirror 108a before again traveling through the beam splitter 106 and into the viewing screen 110. Thus, the beam of light 106 is split and the resulting two beams are made to follow a trajectory in opposite directions. To act as a ring the trajectory must enclose an area. On return to the point of entry the light is allowed to exit the apparatus in such a way that an interference pattern is obtained. The position of the interference fringes is dependent on the angular velocity of the setup.

Usually several mirrors are used, so that the light beams follow a triangular or square trajectory. Fiber optics can also be employed to guide the light. The ring interferometer is located on a platform that can rotate. When the platform is rotating the lines of the interference pattern are displaced as compared to the position of the interference pattern when the platform is not rotating. The amount of displacement is proportional to the angular velocity of the rotating platform. The axis of rotation does not have to be inside the enclosed area.

When the platform is rotating, the point of entry/exit moves during the transit time of the light. So one beam has covered less distance than the other beam. This creates the shift in the interference pattern. Therefore, the interference pattern obtained at each angular velocity of the platform features a different phase-shift particular to that angular velocity.

The type of ring interferometer described above is sometimes called a ‘passive ring interferometer’ because it uses light entering the setup from outside. The interference pattern that is obtained is a fringe pattern, and what is measured is a phase shift.

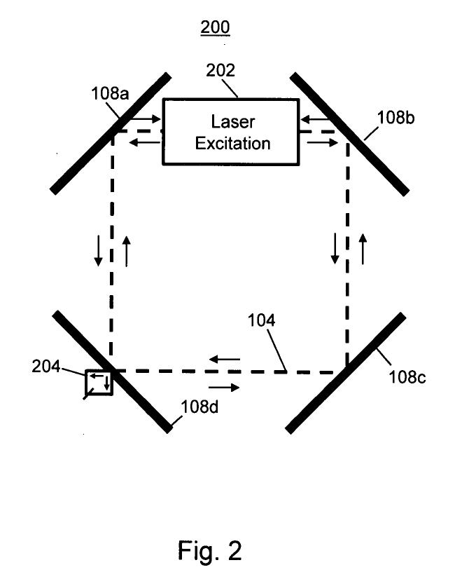

It is also possible to construct a ring interferometer that is self-contained, based on a completely different arrangement. The light is generated and sustained by incorporating laser excitation at some point in the ring-shaped path of the light. The ring-shaped laser cavity is enclosed, and the lasing medium must not come in contact with outside air. This setup, which is depicted in FIG. 2, is called a ring laser. Referring to FIG. 2, an exemplary ring laser 200 includes a laser excitation device 202 in the path of a light beam 104 that is reflecting in opposite directions off mirrors 108a, 108b, 108c, and 108d. At a beam sampling device 204, a fraction of each of the counter propagating light beams 104 exits the laser cavity.

To understand what happens in a ring laser cavity, it is helpful to discuss the physics of the laser process in a laser setup with continuous generation of light. As the laser excitation is started, the atoms or molecules inside the cavity emit photons, but since the atoms have a thermal velocity, the light inside the laser cavity is at first a range of frequencies, corresponding to the statistical distribution of velocities. The process of stimulated emission makes one frequency quickly outcompete other frequencies, and after that the light is extremely close to monochromatic.

When a ring laser is rotating, the laser process generates two frequencies of laser light. In every section of the ring laser cavity, the light propagates with the same velocity in either direction. The atoms in the laser cavity have a thermal velocity, and on average they have a velocity in counter-clockwise direction along the ring. The molecules in the laser cavity can be seen as resonators. A passing photon will stimulate emission of the excited molecule only if the frequency of the passing photon exactly matches the frequency of the photon that the molecule is ready to emit.

A photon that is emitted in counter-clockwise direction is on average Doppler-shifted to a higher frequency, a photon that is emitted in clockwise direction is on average Doppler-shifted to a lower frequency. The upwards Doppler-shifted photons are more likely to stimulate emission on interaction with molecules that they “catch up with”, the downwards shifted photons are more likely to stimulate emission on interaction with molecules that they meet “head on”. Seen in this way, the fact that the ring laser generates two frequencies of laserlight is a direct consequence of the fact that everywhere along the ring the velocity of light is the same in both directions. The constancy of the speed of light acts as a constant background, and the molecules inside the laser cavity have a certain velocity with respect to that background. This constant background is referred to as inertial space.

The laser light that is generated is sampled by causing a fraction of the light to exit the laser cavity. By bringing the two frequencies of laserlight to interference a beat frequency is obtained; the beat frequency is the difference between the two frequencies. This beat frequency can be thought of as an interference pattern in time (i.e., a temporal interference pattern), where the more familiar interference fringes of interferometry correspond to a spatial interference pattern. The period of this beat frequency is linearly proportional to the angular velocity of the ring laser with respect to inertial space.

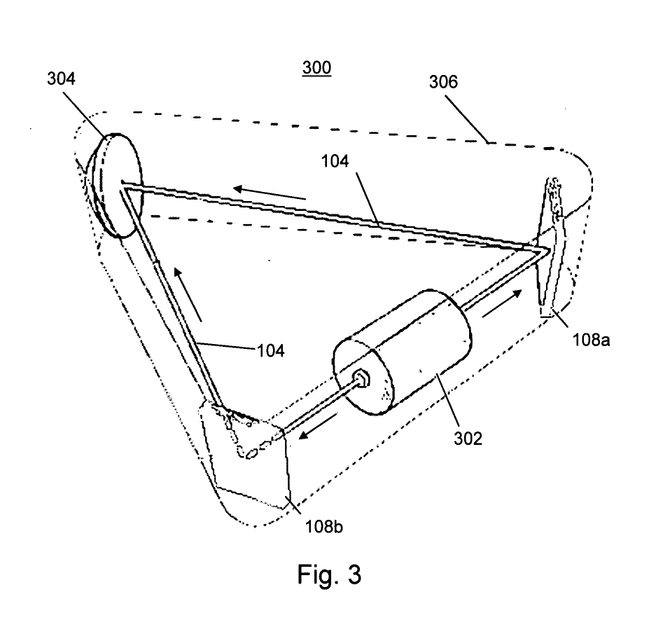

FIG. 3 depicts an exemplary ring laser gyroscope 300. Referring to FIG. 3, a ring laser gyroscope includes a laser source 302 that outputs a laserlight 104 in two directions. The laserlight 104 reflects off mirrors 108a and 108b and arrives at a sensor 304 that measures differences in frequency of the arriving laserlight beams 104. The beam 104 that is traveling in the direction of rotation of the platform (e.g., a plane) has a longer distance to travel and thus a lower frequency. Conversely, the beam traveling against the direction of motion has a shorter path and a higher frequency. The difference in frequency is directly proportional to the rotation rate.

One of the inherent difficulties of the laser gyro is the problem of frequency “lock-in.” As previously mentioned, the laser gyro measures turning rate by sensing frequency differences. When the rate of turn is very small and thus the frequency difference between the two beams is also small, there is a tendency for the two frequencies to couple together, or “lock-in,” and a zero turning rate is indicated. Lock-in limits the accuracy of the laser gyro at important low turn rates. Fortunately, there are several ways to overcome the problem of lock-in. The approach currently used in production devices is to “dither,” or vibrate, the gyroscope, either mechanically or electromagnetically. This dithering of the laser gyroscope adds to the complexity, weight, and size of the device, and, in the case of mechanical dithering, adds moving mechanical parts.

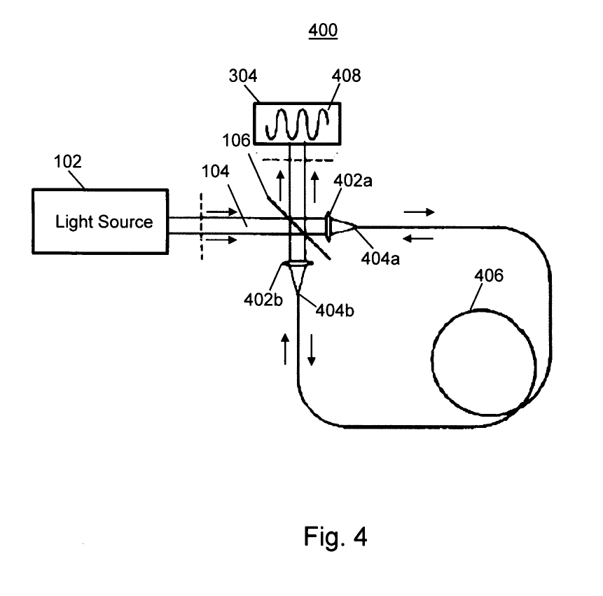

FIG. 4 depicts an exemplary fiber optic gyroscope 400. Referring to FIG. 4, a fiber optic gyroscope 400 includes a light source 102 that produces a light beam 104. The light beam 104 encounters a beam splitter 106 causing part of the light beam 104 to proceed through a lens 402a and into a fiber end 404a while the remaining part of the light beam 104 reflects off the beam splitter 106 and is directed through a lens 402b and into a fiber end 404b. The two parts of the light beam 104 travel in opposite directions through an N-turn fiber coil 406 until they are then directed by the beam splitter 106 to a reader/sensor 304, where a detected fringe pattern 408 corresponds to the angular velocity of the FOG 400.

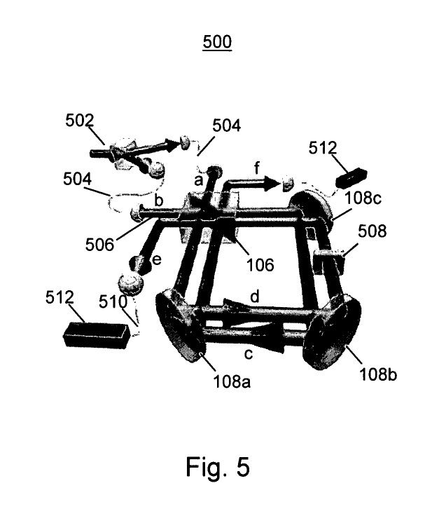

In the May 12, 2008 edition of Science magazine (Vol. 316, pp. 726-729), which is incorporated herein by reference, Nagata et al. disclose an optical interferometer for precision phase measurement that is based on entanglement of N particles, for example 4 entangled protons, that is able to measure a phase with a precision equaling the Heisenberg limit and outperforming the standard quantum limit. FIG. 5 provides a schematic of the optical interferometer 500 that employs an intrinsically stable displaced-Sagnac architecture to ensure that the optical path lengths in modes c and d are sub-wavelength (nm) stable. According to the magazine article, a frequency-doubled 780-nm fs-pulsed laser (repetition interval 13 ns) was used to pump a type I phase-matched beta barium borate (BBO) crystal 502 to generate the state |22>_{ab} via spontaneous parametric down-conversion. Interference filters (not shown) with a 4-nm bandwidth were used. The photons are guided via polarization-maintaining fibers (PMFs) 504 to the interferometer 506 where photons are input in modes a and/or b, and detected in modes e and/or f, after a phase shift (PS) is applied to mode d. A variable phase shift in mode d is realized by changing the angle of the phase plate (PP) 508 in the interferometer 506. Photons are collected in single-mode fibers (SMFs) 510 at the output modes and detected with a single-photon counting module (SPCM, detection efficiency 60% at 780 nm) 510 in modefand three cascaded SPCMs 512 in mode e.

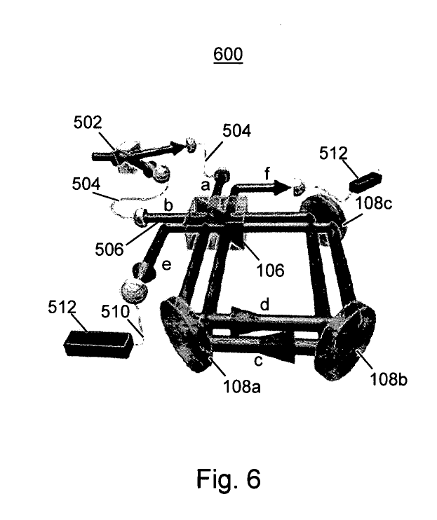

FIG. 6 depicts an exemplary gyroscope in accordance with the present invention. Referring to FIG. 6, gyroscope 600 is very similar to the optical interferometer 500 except that the gyroscope 600 does not include a phase plate 508 and, instead of phase measurement, the gyroscope measures an interference pattern (i.e., a spatial interference pattern and/or temporal interference pattern) that occurs when the apparatus is rotated in a manner analogous to a RLG or FOG. For example, the SPCMs 510 may be used to detect and count the sub-wavelength fringes that indicate the direction and degree of angular rotation about the central axis of the apparatus. Similarly, detectors may be used to measure a beat frequency.

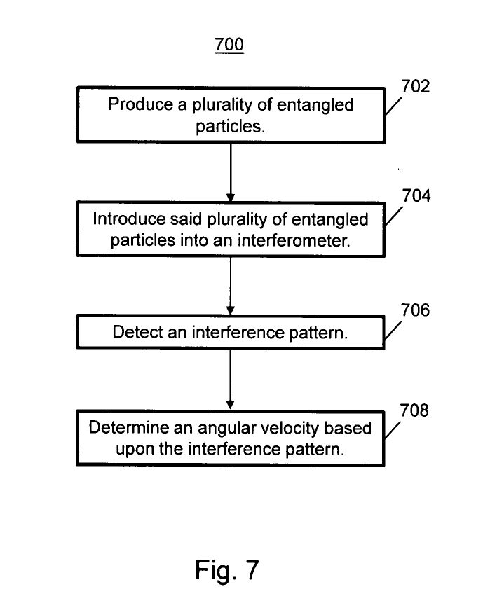

FIG. 7 depicts an exemplary method in accordance with the present invention. Referring to FIG. 7, a method 700 includes four steps. A first step 702 is to produce a plurality of entangled particles. In a second step 704, the entangled particles are introduced into an interferometer. In a third step 706, an interference pattern is detected. In a fourth step 708, the interference pattern is used to determine an angular velocity.

The present invention should provide twice the angular resolution of conventional interferometer based RLGs and FOGs. Furthermore, the present invention should greatly reduce or eliminate lock in experienced by such prior art RLGs and FOGs thereby eliminating the requirement for dithering thereby saving in weight, size, and complexity and therefore cost of RLGs and FOGs employing the present invention.

While particular embodiments of the invention have been described, it will be understood, however, that the invention is not limited thereto, since modifications may be made by those skilled in the art, particularly in light of the foregoing teachings.

1. A method for determining the angular velocity of a platform relative to a gyroscope, comprising:
producing a plurality of entangled particles at a source;
introducing said plurality of entangled particles into an interferometer;
detecting an interference pattern using one or more detectors; and
determining said angular velocity of said platform based upon said interference pattern.

2. The method of claim 1, wherein said interference pattern comprises at least one of a temporal interference pattern or a spatial interference pattern.

3. The method of claim 1, further comprising:
splitting said plurality of entangled particles into a first portion of entangled particles and a second portion of entangled particles; and
directing said first portion of entangled particles and said second portion of entangled particles to follow a trajectory in opposite directions.

4. The method of claim 1, wherein said plurality of entangled particles comprises four entangled particles.

5. The method of claim 1, wherein said plurality of entangled particles comprises photons, atoms, or trapped ions.

6. The method of claim 1, wherein said detecting an interference pattern comprises detecting and counting sub-wavelength fringes that indicate the direction and degree of angular rotation about the central axis of the platform.

7. The method of claim 1, wherein said detecting an interference pattern comprises detecting an interference beat frequency.

8. The method of claim 1, wherein said source produces spontaneous parametric down-conversion.

9. A gyroscope for determining an angular velocity of a platform, comprising:
a source, said source producing a plurality of entangled particles;
an interferometer, said plurality of entangled particles being introduced into said interferometer; and
a detector to detect an interference pattern, said gyroscope determining the angular velocity of said platform based upon said detected interference pattern.

10. The gyroscope of claim 9, wherein said interference pattern comprises at least one of a temporal interference pattern or a spatial interference pattern.

11. The gyroscope of claim 9, wherein said interferometer comprises one of a Mach-Zehnder interferometer, a Sagnac interferometer, a displaced Sagnac interferometer, or a passive ring interferometer.

12. The gyroscope of claim 9, wherein said gyroscope is one of a ring laser gyroscope or a fiber optic gyroscope.

13. The gyroscope of claim 9, wherein said plurality of entangled particles comprises four entangled particles.

14. The gyroscope of claim 9, wherein said plurality of entangled particles comprises photons, atoms, or trapped ions.

15. The gyroscope of claim 9, wherein said detector comprises a single particle counting detector.

16. The gyroscope of claim 9, wherein said source comprises a pulsed laser.

17. The gyroscope of claim 16, wherein said pulsed laser pumps a type I phase-matched beta barium borate crystal.

18. The gyroscope of claim 9, further comprising:
polarization-maintaining fibers that guide said photons from said source to said interferometer.

19. The gyroscope of claim 9, further comprising:
single-mode fibers that collect photons from said interferometer and guide said photons to said detector.

20. The gyroscope of claim 9, further comprising:
at least one interference filter.
